(19) United States
(12) Patent Application Publication
(10) Pub. No.: US 2008/0078363 A1
(43) Pub. Date: Apr. 3, 2008

(54) Fuel vaporization system and method

(75) Inventor: Robert C. Apperson, Riverton, UT (US)

Correspondence Address: ALAN J. HOWARTH, P.O. BOX 1909, SANDY, UT, 84091-1909, US

(73) Assignee: John D. Sims

(21) Appl. No.: 11/540,147

(22) Filed: Sep. 28, 2006

(51) Int. Cl. F02G 5/00; F02M 23/00

(52) U.S. Cl. 123/557; 123/533

(57) ABSTRACT

The invention relates to a system and method for vaporizing liquid fuel. In an exemplary embodiment, the invention includes a pressurized air source, a liquid fuel source, a fuel/air mixer for combining air from the compressed air source and fuel from the fuel source into a fuel/air mixture, and a heat exchanger for vaporizing any liquid fuel in the fuel/air mixture.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. The Field of the Invention

The present invention relates generally to fuel systems for engines, and more particularly, but not necessarily entirely, to fuel systems that vaporize liquid fuel supplied to internal combustion engines to increase fuel efficiency and engine performance.

2. Description of Related Art

For an internal combustion engine to function, fuel must be in a gaseous or vaporized state. Improved vaporization of the fuel results in improved efficiency and decreased emissions. Attempts have been made in the past to provide a more completely vaporized fuel to an internal combustion engine.

U.S. Patent Publication No. 2004/0237948 (published Dec. 2, 2004, to Magyari) discloses a system for vaporizing liquid fuel utilizing photonic energy while minimizing thermal energy.

U.S. Patent Publication No. 2004/0200461 (published Oct. 14, 2004, to Chu) discloses a fuel injection system for a combustion engine that includes a fuel vaporization chamber having a two-way valve. The fuel vaporization chamber includes a means for heating fuel, a fuel control means for controlling fuel flow into the chamber, and a flow control means for controlling the flow of vaporized fuel out of the chamber.

U.S. Patent Publication No. 2005/0005918 (published Jan. 13, 2005, to Newhouse et al.) discloses a method and apparatus for vaporizing liquid fuel. The fuel is pre-heated by means of a fuel line heater prior to a vaporization chamber. The vaporization chamber consists of a heating means by which liquid fuel entering the chamber is heated to boiling and vaporized. The vaporized fuel is fed to the intake manifold of an internal combustion engine.

U.S. Patent Publication No. 2005/0193993 (published Sep. 8, 2005, to Dale) discloses a fuel vaporization system for internal combustion engines. The fuel is vaporized under super-atmospheric pressure. Glow plugs may be used to vaporize the fuel.

U.S. Patent Publication No. 2005/0011499 (published Jan. 20, 2005, to Hara et al.) discloses a system and method for vaporized fuel processing.

U.S. Patent Publication No. 2003/0089347 (published May 15, 2003, to Bushnell et al.) discloses a vapor-fueled engine. A vapor producing chamber includes a gas inlet having a connection to the vehicle fuel tank. A reservoir of liquid fuel is maintained in the bottom of the chamber. A coil selectively heats or cools the liquid fuel in the bottom of the chamber to maintain the fuel at a constant temperature regardless of the outside temperature.

U.S. Patent Publication No. 2006/0042565 (published Mar. 2, 2006, to Hu) discloses an integrated fuel injection system for on-board fuel reformer. An intensifier is used to pressurize fuel. The pressurized fuel at increased pressure is passed through a nozzle. As the fuel leaves the nozzle, it atomizes and partially vaporizes. The fuel is further vaporized in a heat exchanger before passing over a reformer catalyst.

U.S. Patent Publication No. 2005/0028793 (published Feb. 10, 2005, to Pellizzari et al.) discloses a hybrid fuel vaporization system. The fuel vaporization system includes at least one capillary flow passage. A heat source is operable to heat the fuel in the at least one capillary flow passage to change its state from a liquid to a gas.

U.S. Pat. No. 6,758,194 (granted Jul. 6, 2004, to Shetley et al.) provides a parallel fuel vaporization system. The system provides vaporized fuel to an internal combustion engine for general driving, and a liquid fuel is supplied for immediate and heavy acceleration.

U.S. Pat. No. 5,896,847 (granted Apr. 27, 1999) provides a liquefied fuel vaporizing apparatus for vaporizing a liquefied fuel.

U.S. Pat. No. 4,955,351 (granted Sep. 11, 1990, to Lewis et al.) discloses an invention that vaporizes a liquid fuel through a pressure differential inside a closed container. The vaporized fuel is transferred to the engine through a constant vacuum. A variable gascock valve regulates the flow of vapor.

U.S. Pat. No. 4,499,886 (granted Feb. 19, 1985, to Hinds) discloses a diesel fuel heater. The fuel heater bolts onto a vehicle. The fuel is heated using hot crankcase oil.

U.S. Pat. No. 4,498,447 (granted Feb. 12, 1985, to Harvey) discloses an apparatus capable of delivering fuel vapor directly to a carburetor. The fuel is vaporized by spraying the fuel on copper tubing filled with hot water from the engine cooling system.

U.S. Pat. No. 4,412,521 (granted Nov. 1, 1983, to Silva, Jr.) discloses an evaporative carburetor and engine. Fuel is delivered into a heated tray located in a pressure-tight chamber. The heat from the tray causes the liquid fuel to vaporize. A vaporizing passage carries the vaporized fuel to a mixing station, where the fuel is mixed with air.

U.S. Pat. No. 4,401,095 (granted Aug. 30, 1983, to DuLoft) discloses a fuel-air mixing device. The device comprises a chamber within which air and fuel are caused to mix. The air and fuel are mixed via air turbulence within the chamber.

U.S. Pat. No. 4,345,570 (granted Aug. 24, 1982, to McNeece) discloses a fuel heating apparatus for vehicles. The apparatus includes a fuel vaporized box fitted with an air inlet and a fuel-air mixture discharge outlet. A heat exchanger operates in conjunction with the box to vaporize the fuel. Hot water is used to supply heat to the heat exchanger.

U.S. Pat. No. 4,350,134 (granted Sep. 21, 1982, to Sparks) discloses a method and apparatus for producing an air/fuel mixture. An enclosure includes an air heating means for heating the ambient air. The heating means is connected with the engine coolant such that heat from the engine is transferred to the heating means.

U.S. Pat. No. 4,329,964 (granted May 18, 1982, to Morris) discloses a carburetion system for metering and supplying fuel for internal combustion engines.

U.S. Pat. No. 4,267,802 (granted May 19, 1981, to Garreston) discloses a fuel delivery system including a vaporizing chamber for combining liquid fuel and air to produce a vaporized fuel and air mixture. The vaporizing chamber includes a reservoir for storing a quantity of liquid fuel. A reservoir heater may be used to increase the rate of fuel vaporization.

U.S. Pat. No. 4,014,306 (granted Mar. 29, 1977, to Ingersoll) discloses a fuel vaporizer that is interposed between a carburetor and an intake manifold.

U.S. Pat. No. 4,011,850 (granted Mar. 15, 1977, to Knox, Sr.) discloses a fuel vaporizer for internal combustion engines. The vaporizer is interposed between the intake manifold and the carburetor.

U.S. Patent No. (granted Jun. 21, 1977, to Sugimoto) discloses a method of water admixing to fuel oil for an internal combustion engine.

U.S. Pat. No. 3,999,526 (granted Dec. 28, 1976, to Asfar) discloses a vaporizing carburetor.

U.S. Pat. No. 2,882,882 (granted Apr. 21, 1959, to Pantano) discloses a fuel vaporization unit utilizing the engine exhaust gases.

U.S. Pat. No. 1,980,496 (granted Nov. 13, 1934, to Musselwhite) discloses a device for vaporizing low grade fuel oil.

International Patent Publication No. WO 86/02978 (published May 22, 1986) discloses a fuel vaporization and injection system.

Despite the advantages of known systems and apparatuses, improvements are still being sought. The features and advantages of the invention will be set forth in the description that follows, and in part will be apparent from the description, or may be learned by the practice of the invention without undue experimentation. The features and advantages of the invention may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a schematic illustration of an exemplary system according to the present invention;

FIG. 2 is a cross-sectional view of the heat exchanger illustrated in FIG. 1;

FIG. 3 is another cross-sectional view of the heat exchanger illustrated in FIG. 1;

FIG. 4 is a schematic illustration of another exemplary system according to the present invention;

FIG. 5 is a cross-sectional view of the heat exchanger illustrated in FIG. 4; and

FIG. 6 is a cross-sectional view of another exemplary embodiment.

### DETAILED DESCRIPTION

For the purposes of promoting an understanding of the principles in accordance with the disclosure, reference will now be made to the embodiments illustrated in the drawings and specific language will be used to describe them. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise. As used herein, the terms “comprising,” “including,” “containing,” “characterized by,” and grammatical equivalents thereof are inclusive or open-ended terms that do not exclude additional, unrecited elements or method steps.

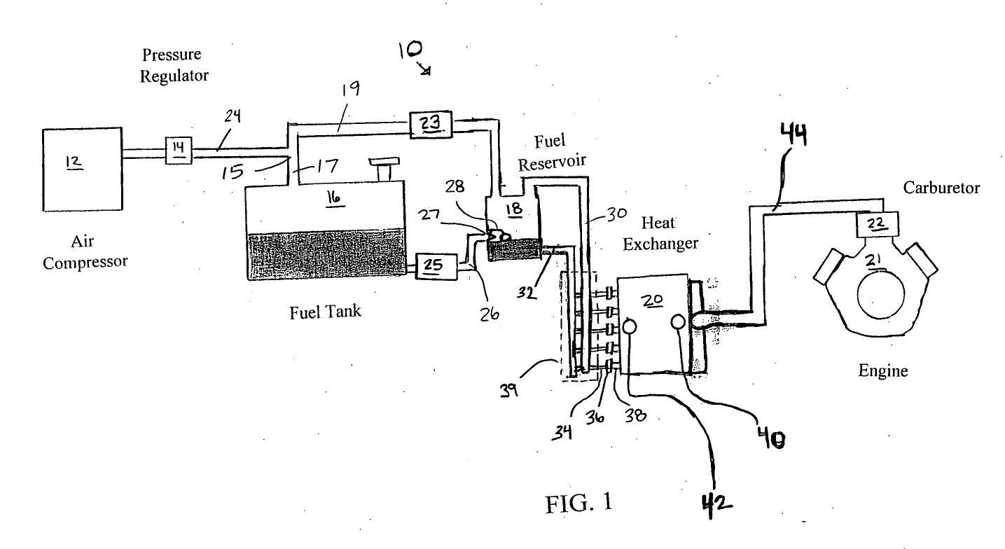

Applicant has discovered a system and method for vaporizing a fuel/air mixture to thereby improve the efficiency of an internal combustion engine. Referring now to FIG. 1, this is shown a schematic illustration of an exemplary embodiment of a fuel system 10 for an internal combustion engine pursuant to the present invention. The system 10 comprises an air compressor 12, a pressure regulator 14, a fuel tank 16, a fuel reservoir 18, a heat exchanger 20, and a carburetor 22.

The air compressor 12 supplies a steady supply of pressurized air via a pressurized air line 24. The pressure regulator 14 maintains the pressure in the air line 24 at a pre-determined level. The air pressure should be maintained typically at a minimum pressure of six (6) pounds per square inch. The pressurized line 24 extends from the compressor 12 to a T-junction 15 proximate to the top of the fuel tank 16. At the T-junction 15, the line 24 is split. One split 17 of line 24 leads into the fuel tank 16. The line 24 maintains the fuel tank 16 at a positive pressure thereby forcing a liquid fuel stored in the tank 16 through a fuel line 26. Thus, the fuel tank 16 must be substantially airtight to maintain the positive pressure within the tank 16. Alternatively, a fuel pump of either electrical or mechanical design may be employed to pump fuel from the fuel tank 16 through the line 26.

The fuel line 26 extends from the fuel tank 16 to the fuel reservoir 18. The fuel reservoir 18 illustratively has the size dimensions of about 4 inches×4 inches×5 inches (0.1 meter×0.1 meter×0.13 meter). The fuel reservoir 18 may be constructed of a heat resistant material having a thickness of about 0.125 inches (0.32 centimeters), for example.

The fuel line 26 terminates inside of the fuel reservoir 18 at a valve 27 controlled by a float mechanism 28. The float mechanism 28 is used to maintain a desired supply level of liquid fuel in the reservoir 18. When the fuel level in the reservoir 18 drops below a desired level, the float of the mechanism 28 also drops thereby opening the valve 27 to permit fuel to enter the reservoir 18. Conversely, as the fuel level rises in the reservoir 18, the float 28 moves upward to thereby close the valve 27 when the desired supply level has been achieved. In this manner, a constant fuel level is maintained in the reservoir 18.

The pressurized air line 24 is also connected to the fuel reservoir 18 via the T-junction 15 discussed above. In particular, the second split 19 from the T-junction 15 leads to the fuel reservoir 18. The air line 24 maintains the interior of the reservoir 18 in a pressurized state. An air supply line 30 extends from the reservoir 18 to an air distribution manifold 39 indicated by the area enclosed in the dashed box in FIG. 1. A fuel supply line 32 extends from the reservoir 18 to the manifold 39 as well for distributing fuel. The manifold 39 distributes air and fuel from the line 30 and the line 32, respectively, to a plurality of fuel/air mixers 36 via a plurality of feeder tubes 34. Each feeder tube 34 directs air and fuel from the air supply line 30 and the fuel supply line 32, respectively, to one of the fuel/air mixers 36. As the name suggests, the fuel/air mixers 36 mix, or further mix, the liquid fuel and pressurized air together to the extent that they have not previously been mixed. The fuel/air mixers 36 may partially vaporize or atomize the liquid fuel into the pressurized air stream. However, complete vaporization of the liquid fuel may not be achieved at this stage.

It should be noted that the air inside of the line 24 and the fuel inside of line 26 may be pre-heated by in-line heaters 23 and 25, respectively. Heaters 23 and 25 utilize a thermal source, such as hot engine exhaust, hot oil, hot cooling fluid, or electric heating elements, to preheat the air and the fuel. For example, the heaters 23 and 25 may comprise tubing coiled around the outside or the inside of the lines 24 and 26 and hot engine coolant may be directed through the tubing. The pre-heating of the air and the fuel facilitates the vaporization of the fuel into the air.

After the fuel/air mixers 36, the fuel/air mixture passes through the heat exchanger 20 in heating tubes 38 connected to the fuel/air mixers 36. In order to further vaporize the fuel/air mixture, the heat exchanger 20 includes an inlet port 40 for receiving a thermal source heated by the engine 21. The thermal source serves as means to heat and vaporize any liquid fuel in the heating tubes 38. An outlet port 42 vents the thermal source after the fuel/air mixture in the heating tubes 38 has been adequately heated to vaporize any remaining liquid fuel. In the case of an automobile and where the thermal source is exhaust gas, the exhaust gas is directed from the outlet port 42 to the exhaust system of the automobile. In the case where the thermal source is oil, the oil is directed back to the engine oil pan or crankcase. In the case where the thermal source is engine coolant, the engine coolant is directed back to the radiator. Further, the inlet port 40 is situated nearest the engine 21 such that the hottest point is just before the fuel enters the engine to thereby maximize the fuel vaporization.

Once vaporized, the fuel/air mixture is pulled via a vapor fuel line 44 from the heat exchanger 20 to a carburetor 22. In one embodiment, the carburetor 22 is a natural gas carburetor that is designed to distribute vaporized fuel and air to an intake manifold or fuel injection system of the engine 21. A natural gas carburetor is adapted to use a non-liquid fuel, such as natural gas, to operate an engine. Thus, one benefit of the present invention is that an engine may have a dual fuel capability. For example, an engine may selectively run on natural gas, propane or a liquid fuel, such as gasoline, with little adjustment to the engine using the same carburetor.

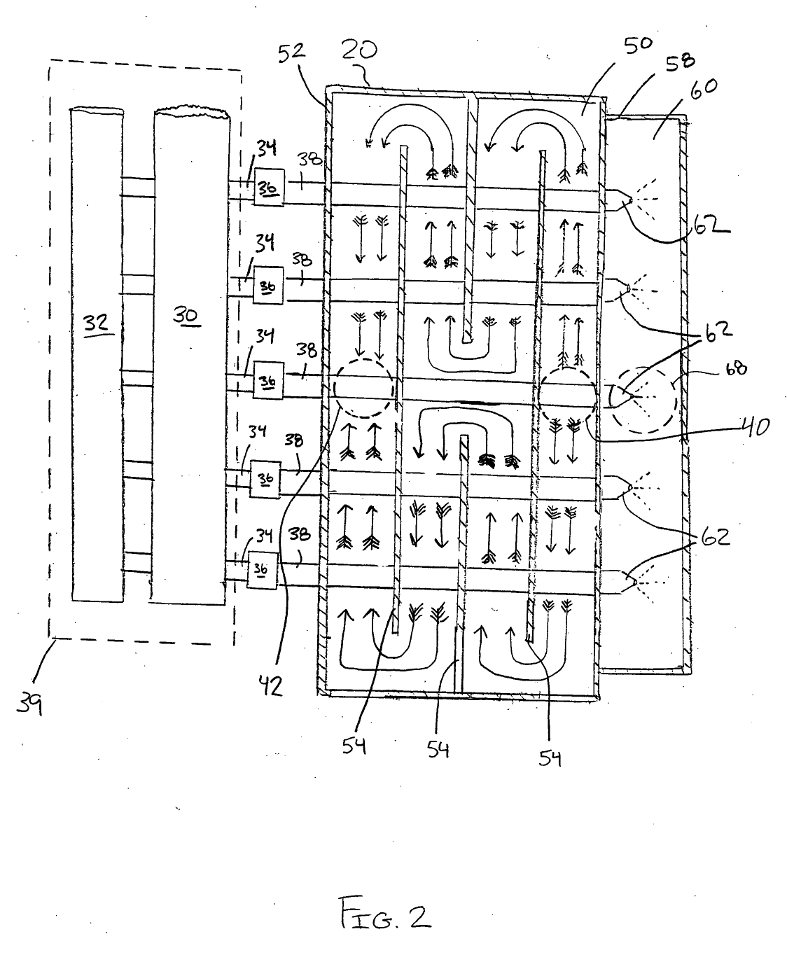

Referring now to FIG. 2, there is shown a cross-sectional view of the heat exchanger 20 illustrated in FIG. 1. As previously discussed, the air supply line 30 and the fuel supply line 32 supply air and fuel, respectively, from the pressurized fuel reservoir 18 to each of a plurality of fuel/air mixers 36 via feeder tubes 34. The distribution of the air and fuel from the lines 30 and 32, respectively, is accomplished via the manifold 39 shown by the dashed box in FIG. 2.

The fuel/air mixers 36 mix the fuel and air together to form a partially vaporized mixture. A plurality of heating tubes 38, one extending from each fuel/air mixer 36, extend into the heat exchanger 20. Optionally, the fuel/air mixers 36 may include an electronic valve means for controlling the flow of air and fuel from the air supply line 30 and the fuel supply line 32, respectively. The valve means may be controlled via a computer based upon the needs of the engine 21 determined by sensors or other inputs. That is, the valve means regulates the flow of air and fuel to the engine 21 based upon the needs of the engine 21. In addition, the valve means may regulate the fuel-to-air ratio of the fuel/air mixture by independently controlling the air and fuel supply from the manifold 39. Typically, the engine 21 will require much more air than fuel to achieve an optimum combustion ratio.

As can be observed in FIG. 2, the heat exchanger 20 comprises two enclosed chambers. A heating chamber 50 is formed by wall 52 that extends around the perimeter of chamber 50. The chamber 50 is further enclosed by a bottom wall and a top wall (not explicitly shown) to form an airtight compartment, except for the openings noted herein. A series of internal baffles 54 are located within the chamber 50 and form a pathway within the chamber 50. The pathway directs a thermal source, such as engine exhaust gases, from the inlet port 40, shown in dashed lines, to the outlet port 42, shown in dashed lines, as shown by the directional arrows in FIG. 2. The directional arrows represent the path taken by the thermal source through the chamber 50.

The positioning of the baffles 54 ensures that the thermal source passes uniformly around each of the heating tubes 38. The thermal source in the chamber 50 serves to heat the fuel/air mixture in the heating tubes 38 to the point where any remaining liquid fuel inside of the tubes 38 is completely vaporized into a gaseous or vaporized state. The thermal source may comprise exhaust gas, engine coolant, or engine oil. Care should be taken not to heat the fuel/air mixture to combustion within the heating tubes 38.

It should be noted that the configuration of the heat exchanger 20 shown in FIG. 2 should not be considered limiting on the present invention. More or fewer baffles 54 may be provided to ensure adequate vaporization of the fuel/air mixture inside of the heating tubes 38. In addition, more or fewer heating tubes 38 may be provided to guarantee an adequate fuel and air supply to the engine 21.

The heating tubes 38 exit the wall 52 of the chamber 50 on the opposite side from which they entered. A vapor chamber 60 is formed by a perimeter wall 58 and a top wall and a bottom wall (not explicitly shown). A vapor outlet port 68, shown by the dashed circle, is formed in the top wall of the vapor chamber 60. Each of the heating tubes 38 terminates inside of the vapor chamber 60 at one of a plurality of nozzles 62. The heated and vaporized fuel/air mixture is injected into the vapor chamber 60 from heating tubes 38 through these nozzles 62. If necessary, the nozzles 62 may be jetted or otherwise configured to further vaporize or atomize any remaining liquid fuel present in the heated fuel/air mixture. It should be noted that the heating chamber 50 and the vapor chamber 60 are adjacent to each other and that they share a common wall. Shielding around the entire heat exchanger 20 can optionally be provided to prevent the unwanted escape of heat from the heat exchanger 20 into an engine compartment. The shielding can also serve to reflect heat back to the heat exchanger 20.

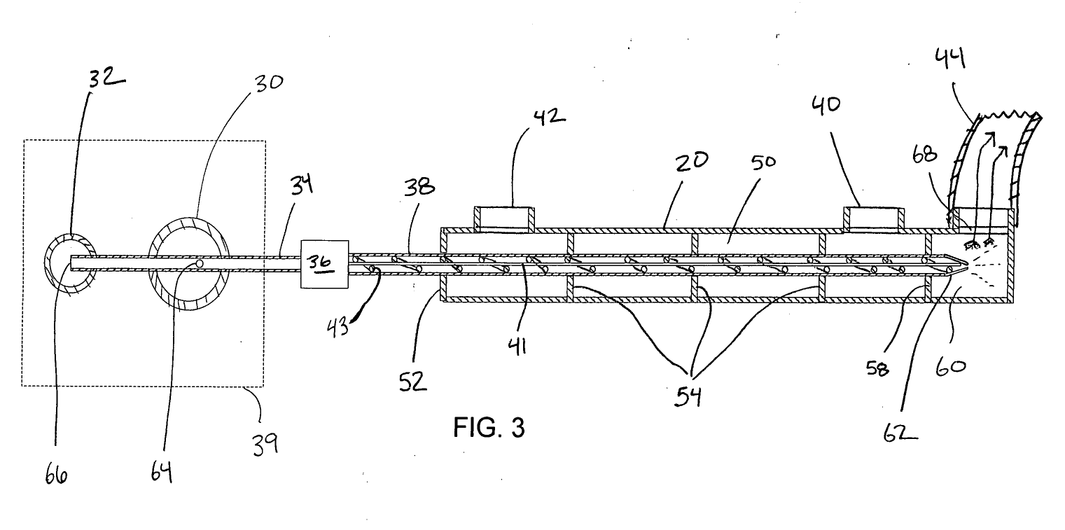

Referring now to FIG. 3, there is shown a cross-sectional view of heat exchanger 20 perpendicular to the cross-sectional view illustrated in FIG. 2. A cross-sectional view of the manifold 39 is also shown. As will be appreciated by those having ordinary skill in the art, the fuel supply line 32 may have a smaller diameter than the air supply line 30 due to the fact that more air is required in an optimized fuel to air combustion ratio.

A port 64 in the feeder tube 34 may allow pressurized air to enter into the feeder tube 34. For that reason, the port 64 is located within the air supply line 30. The liquid fuel enters an open end 66 of the feeder tube 34, which terminates inside of the fuel supply line 32. Thus, there is pre-mixing of the fuel and air in the feeder tube. Alternatively, the air and fuel could be provide separately to the fuel/air mixers 36.

The fuel and air travel through the feeder tube 34 to the fuel/air mixer 36, where the fuel and air are more thoroughly mixed together. As previously mentioned, the heating tube 38 enters the chamber 50 via an opening (not shown) formed in wall 52. The heating tube 38 passes through baffles 54 and through the opposite side of wall 52. In an alternative embodiment, the fuel/air mixers 36 are located within chamber 50 such that the fuel/air mixers 36 are heated in the heat exchanger 20 to facilitate mixing. After passing out of the heating chamber 50, the heating tube 38 enters the vapor chamber 60 through a common wall 58 where the fuel/air mixture is injected, in a vaporized state, into the chamber 60 through nozzle 62.

Located within the heating tube 38 is a needle valve 41 extending from the fuel/air mixer 36 to the nozzle 62. The position of the tip of the needle valve is variable in relation to the nozzle 62 to thereby control the flow of the fuel/air mixture into the vapor chamber 60. The needle valve 41 may be electronically or manually controlled. The needle valve 41 is disposed within a coil 43, also located within the heating tube 38. Near the fuel/air mixer 36, the wind of the coil 43 inside of the heating tube 38 is fairly loose. As the coil 43 approaches the nozzle 62, the winding on the coil 43 is tighter. The purpose of the coil 43 is to disturb the fuel/air mixture as it passes through the heating tube 38. The disturbance caused by the coil 43 causes the fuel/air mixture to more thoroughly mix in the heating tube 38.

Formed in the top of chamber 60 is the vapor outlet 68 in communication with the vaporized fuel line 44. The vaporized fuel line 44 is in communication with the intake of the carburetor 22 (see FIG. 1). It will be appreciated that the chambers 50 and 60 are airtight except for the openings described herein.

The vaporized fuel/air mixture in the chamber 60 is drawn into the line 44, and subsequently the carburetor 22, by a vacuum created by the cylinders of the engine 21. The carburetor 22 distributes the fuel/air mixture to the intake manifold(s) of the engine 21. From there, the fuel/air mixture is drawn into each of the individual cylinders for combustion through the appropriate port heads of each cylinder. In this manner, the engine 21 can intake as much of the fuel/air mixture as is needed to run the engine 21 from the chamber 60.

Although not shown, a return line may be connected to an opening in the bottom of chamber 60 for returning un-vaporized fuel to either the fuel tank 16 or the fuel reservoir 18. This will prevent unused liquid fuel from accumulating in the bottom of chamber 60.

It should be noted that various thermal sources may be passed through the heat exchanger 20, including hot engine exhaust, hot engine coolant, and hot engine oil. Also, electrical heating elements may also be used. In addition, the pressurized air may be preheated before mixture with the fuel. It will be appreciated that the structure and apparatus disclosed herein is merely one example of a means for heating and vaporizing the fuel/air mixture, and it should be appreciated that any structure, apparatus, or system for heating and vaporizing the fuel/air mixture which performs functions the same as, or equivalent to, those disclosed herein are intended to fall within the scope of a means for heating and vaporizing the fuel/air mixture, including those structures, apparatuses, or systems for heating and vaporizing the fuel/air mixture that are presently known, or that may become available in the future. Anything that functions the same as, or equivalently to, a means for heating and vaporizing the fuel/air mixture falls within the scope of this element.

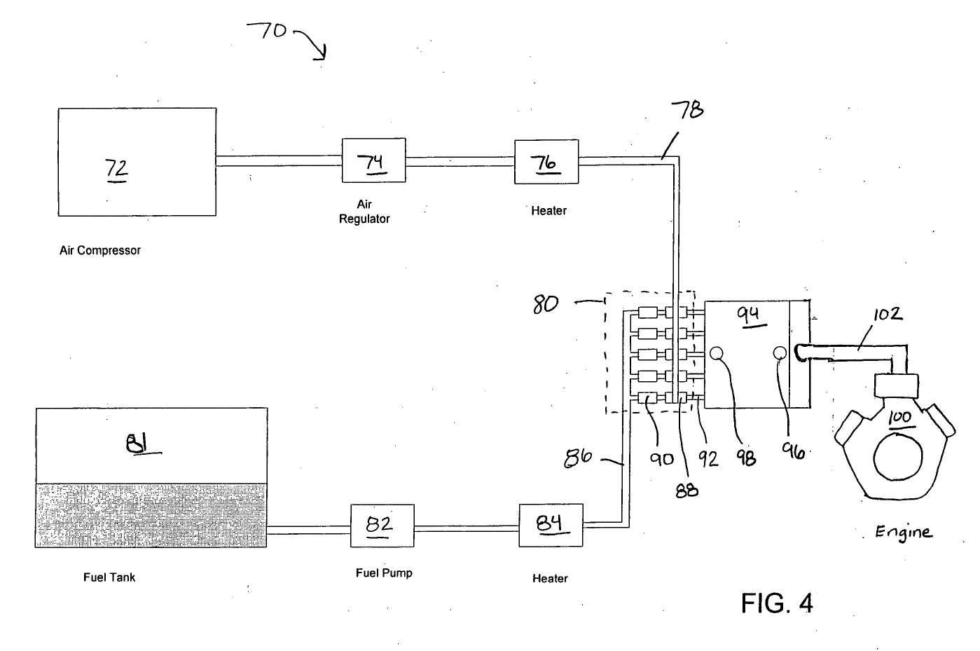

Referring now to FIG. 4, there is shown another embodiment of a system 70 according to the principles of the present invention. The system 70 comprises an air compressor 72, an air regulator 74, and an air heater 76. The air compressor 72 supplies a flow of compressed air to the system 70. The air regulator 74 maintains pressure in a line 78 at a predetermined level. The heater 76 pre-heats the compressed air in the line 78.

The system 70 also comprises a fuel tank 81, a fuel pump 82 and a heater 84. The fuel tank 81 contains a supply of liquid fuel. The fuel pump 82 pumps fuel from the fuel tank 81 through a line 86. The heater 84 pre-heats the fuel in the fuel line 86.

The lines 78 and 86 both lead to a manifold 80 indicated by the dashed box in FIG. 4. The air line 78 supplies a series of electronically controlled air injectors 88. The fuel line 86 supplies a series of electronically controlled fuel injectors 90. The air injectors 88 and the fuel injectors 90 supply a plurality of heating tubes 92 with air and fuel, respectively. As can be observed in FIG. 4, the heating tubes 92 extend into a heat exchanger 94.

The heat exchanger 94 includes an inlet port 96 for receiving a thermal source heated by an engine 100. The thermal source serves as means to heat and vaporize any liquid fuel in the heating tubes 92. An outlet port 98 vents the thermal source after the fuel/air mixture in the heating tubes 92 has been adequately heated to vaporize any remaining liquid fuel. In the case of an automobile and where the thermal source is exhaust gas, the exhaust gas is directed from the outlet port 98 to the exhaust system of the automobile. In the case where the thermal source is oil, the oil is directed back to the engine oil pan or crankcase. In the case where the thermal source is engine coolant, the engine coolant is directed back to the radiator. Further, the inlet port 96 is situated nearest the engine 100 such that the hottest point is just before the fuel enters the engine to thereby maximize the fuel vaporization. Once vaporized inside of the heat exchanger 94, the fuel/air mixture is pulled via a vapor fuel line 102 from the heat exchanger 94 to the engine 100.

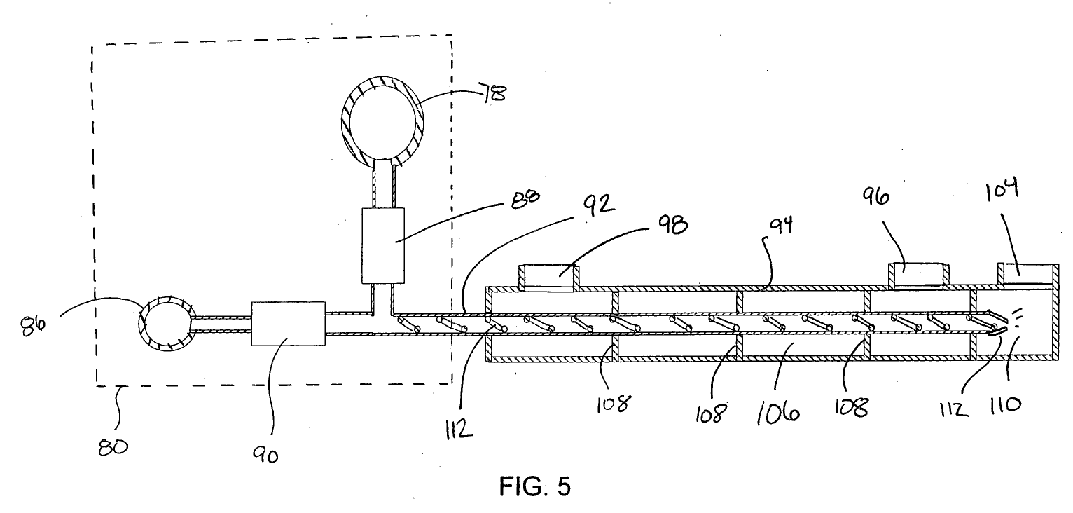

Referring to FIG. 5, the is shown a cross-sectional view of the manifold 80 and the heat exchanger 94. The amount of air supplied from the air supply line 78 to the heating tube 92 is controlled by the air injector 88. The amount of fuel from the fuel line 86 to the heating tube 92 is controlled by the fuel injector 90. The air injector 88 and fuel injector 90 may be controlled by a computer to ensure that the correct air/fuel mixture is supplied to the engine 100.

The heating tube 92 extends through a heating chamber 106 that includes baffles 108. The baffles 108 may be positioned similarly to the baffles 54 shown in FIG. 2 to thereby form a passage between inlet 96 and outlet 98 of the heat exchanger 94. The heating tube 92 terminates in chamber 110 at a nozzle 112. The vaporized fuel/air mixture in the chamber 110 may then be supplied to engine 100 through an outlet 104 in the chamber 110. The heating tube 92 includes a coil 112 to assist in creating turbulence inside of the tube 92 to facilitate the mixing of the fuel and air.

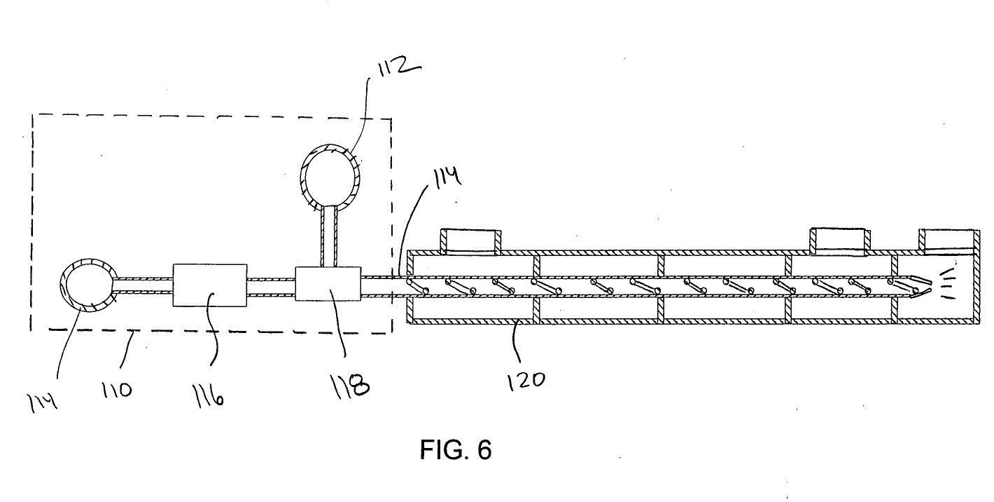

Referring now to FIG. 6, there is shown an alternative embodiment of a manifold 110 that supplies a heating tube 114 that passes into a heat exchanger 120. An air supply line 112 supplies air to a mixer 118, such as an air injector. A fuel supply line 114 supplies air to a fuel injector 116. The fuel injector 116 and the mixer 118 are in series with each other. Leaving the mixer 118 into tube 114 is a fuel/air mixture. The fuel/air mixture is then further vaporized in the heat exchanger 120. The heat exchanger 120 may take the form of the heat exchangers 20 and 84.

The improved vaporization provided by the present invention of the liquid fuel results in increased efficiency and economy through a more complete combustion of the fuel in the cylinders of an engine. In addition, harmful pollutants are reduced by the improved vaporization techniques described herein.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of any single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly, and use may be made without departing from the principles and concepts set forth herein.

What is claimed is:

1. A system for vaporizing liquid fuel supplied to an engine, the system comprising:
a compressed air source;
a fuel source;
a fuel/air mixer coupled to the compressed air source and the fuel source for receiving air from the compressed air source and fuel from the fuel source and combining the air and fuel into a fuel/air mixture;
a heat exchanger coupled to the fuel/air mixer for heating and vaporizing any liquid fuel contained in the fuel/air mixture; and
a supply line coupled to the heat exchanger for supplying the heated and vaporized fuel/air mixture from the heat exchanger to the engine.

2. The system of claim 1 further comprising a pressure regulator coupled to the compressed air source for controlling the compressed air source.

3. The system of claim 1 wherein the compressed air source pressurizes the fuel source to enable fuel flow.

4. The system of claim 1 wherein said heat exchanger comprises at least one heating tube for carrying the fuel/air mixture.

5. The system of claim 4 further comprising a manifold coupled to the fuel/air mixer for distributing the fuel/air mixture to the at least one heating tube.

6. The system of claim 1 wherein the heat exchanger comprises an air-tight chamber, an inlet, and an outlet, the air-tight chamber comprising a series of baffles for channeling hot engine exhaust gases from the inlet to the outlet.

7. The system of claim 1 wherein the heat exchanger comprises one or more electrical heating elements for vaporizing the fuel/air mixture.

8. The system of claim 1 wherein the heat exchanger utilizes hot engine coolant for vaporizing the fuel/air mixture.

9. The system of claim 1 wherein the heat exchanger utilizes hot oil for vaporizing the fuel/air mixture.

10. The system of claim 1 further comprising a carburetor, said carburetor being interposed between the supply line and the engine.

11. The system of claim 10 wherein the carburetor comprises a natural gas carburetor.

12. The system of claim 1 further comprising an air-tight chamber, said air-tight chamber storing the heated and vaporized fuel/air mixture until its is drawn into the engine through the supply line.

13. A system for vaporizing liquid fuel supplied to an engine, said system comprising:
an air source;
a fuel source;
a plurality of fuel/air mixers, each coupled to the air source and the fuel source, for combining air from the air source and fuel from the fuel source into a fuel/air mixture;
a first manifold coupled to fuel source and the plurality of fuel/air mixers for supplying fuel from the fuel source to the fuel/air mixers; and
a heat exchanger coupled to the plurality of fuel/air mixers for heating and vaporizing any liquid fuel in the fuel/air mixture.

14. The system of claim 13 further comprising a second manifold coupled to air source and the plurality of fuel/air mixers for supplying air from the air source to the plurality of fuel/air mixers.

15. The system of claim 13 wherein the heat exchanger further comprises a plurality of heating tubes for circulating the fuel/air mixture, and each of the plurality of heating tubes having a first end and a second end.

16. The system of claim 15 wherein the second end of each of the plurality of heating tubes terminates in a chamber.

17. The system of claim 16 further comprising a nozzle at each of the second ends of the plurality of heating tubes.

18. The system of claim 16 further comprising a vapor communication path from the chamber to the engine.

19. The system of claim 13 wherein the air source is a compressed air source.

20. The system of claim 13 wherein the heat exchanger comprises an air-tight chamber, an inlet, and an outlet, the air-tight chamber comprising a series of baffles for channeling hot engine exhaust gases from the inlet to the outlet.

21. The system of claim 13 wherein the heat exchanger comprises one or more electrical heating elements for vaporizing the fuel/air mixture.

22. The system of claim 13 wherein the heat exchanger utilizes hot engine coolant for vaporizing the fuel/air mixture.

23. The system of claim 13 wherein the heat exchanger utilizes hot oil for vaporizing the fuel/air mixture.

24. A heat exchanger for use with a fuel vaporization system, said heat exchanger comprising:
a first chamber and a second chamber;
a heating tube traversing the first chamber and terminating in the second chamber;
an inlet and an outlet for the first chamber;
a pathway formed between the inlet and the outlet to thereby allow a thermal source to pass through the first chamber; and
a vapor outlet formed in the second chamber for supplying a vaporized fuel/air mixture to an engine.

25. The heat exchanger of claim 24 wherein the first chamber and the second chamber are adjacent to each other.

26. The heat exchanger of claim 24 wherein the thermal source is hot engine exhaust.

27. The heat exchanger of claim 24 wherein the thermal source is hot engine coolant.

28. The heat exchanger of claim 24 where the thermal source is hot oil.

29. The heat exchanger of claim 24 further comprising a plurality of heating tubes traversing the first chamber and terminating in the second chamber.

30. The heat exchanger of claim 24 wherein the vapor outlet is in vapor communication with a natural gas carburetor attached to the engine.

31. The heat exchanger of claim 24 further comprising a nozzle disposed on an end of the heating tube terminating in the second chamber.

32. The heat exchanger of claim 31 further comprising a needle valve to control flow through the nozzle.

33. The heat exchanger of claim 24 further comprising a coil inside of the heating tube.

34. The heat exchanger of claim 33 wherein the wind on the coil varies along its length.

35. The heat exchanger of claim 24 wherein the heating tube is adapted to transport a fuel/air mixture.

36. The heat exchanger of claim 24 wherein the pathway is formed by a plurality of baffles inside of the heat exchanger.

37. A method of vaporizing liquid fuel prior to combustion in an engine, said method comprising:
distributing pressurized air from a compressor to each of a plurality of fuel/air mixers;
distributing liquid fuel to each of the plurality of fuel/air mixers;
combining the pressurized air and the liquid fuel to form a fuel/air mixture;
directing the fuel/air mixture to a heat exchanger through one or more heating tubes;
vaporizing any liquid fuel in the fuel/air mixture at the heat exchanger; and
supplying the vaporized fuel/air mixture to the engine.

38. The method of claim 37 wherein said distributing the pressurized air further comprises distributing the pressurized air using a manifold.

39. The method of claim 37 wherein said distributing the liquid fuel further comprises distributing the liquid fuel using a manifold.

40. The method of claim 37 wherein said distributing the liquid fuel further comprises distributing the liquid fuel from a pressurized fuel reservoir.

41. The method of claim 37 further comprising controlling the fuel to air ratio.

42. The method of claim 37 further comprising heating the fuel/air mixture using a thermal source selected from the group consisting of exhaust gas, engine coolant, and oil.

43. The method of claim 37 further comprising heating the fuel/air mixture using an electrical heating element.

44. The method of claim 37 wherein said providing the vaporized fuel/air mixture to the engine comprises providing the fuel/air mixture to a natural gas carburetor.

45. The method of claim 37 further comprising injecting the vaporized fuel/air mixture into a chamber.

46. A system for vaporizing liquid fuel supplied to an engine, said system comprising:
a fuel supply;
a heat exchanger, the heat exchanger comprising an inlet tube for carrying fuel into the heat exchanger; and
an electronically controlled fuel injector;
wherein the fuel injector injects fuel from the fuel supply into the inlet tube of the heat exchanger.

47. The system of claim 46 further comprising an electronically controlled air injector, the air injector injecting air into the inlet tube of the heat exchanger.

48. The system of claim 46 further comprising a coil disposed in the inlet tube.

49. The system of claim 46 further comprising a fuel heater for heating fuel from the fuel supply prior to the fuel injector.
